(19) United States
(12) Patent Application Publication
(10) Pub. No.: US 2020/0168051 A1
(43) Pub. Date: May 28, 2020

(54) METHOD AND SYSTEM FOR WAGERING ON SPORTING EVENTS

(71) Applicant: Equilottery LLC, Louisville, KY (US)

(72) Inventor: Bradford Cummings, Louisville, KY (US)

(21) Appl. No.: 16/779,063

(22) Filed: Jan. 31, 2020

Related U.S. Application Data
(63) Continuation of application No. 16/188,562, filed on Nov. 13, 2018.
Application No. 16/188,562 is a continuation of application No. 15/079,360, filed on Mar. 24, 2016, now abandoned.
(60) Provisional application No. 62/144,629, filed on Apr. 8, 2015.

(51) Int. Cl. G07F 17/32

(52) U.S. Cl. CPC G07F 17/3288; G07F 17/3225; G07F 17/3244

(57) ABSTRACT

In a method and system for wagering on sporting events, multiple point-of-purchase terminals are provided for generating tickets, with each ticket including a series of player-selected numbers (or other alphanumeric characters or symbols) or a series of randomly generated numbers (or other alphanumeric characters or symbols), each number corresponding to a selected outcome associated with the one or more sporting events. A first predetermined portion of the purchase price is allocated to a wager on the selected outcomes, which is placed with a sportsbook. Another portion of the purchase price is allocated to a secondary payout pool. Occurrence of the one or more sporting events results in a series of winning outcomes and a payout. The secondary payout pool can then be accessed to award consolation prizes and/or supplement payouts.

### CROSS-REFERENCE TO RELATED APPLICATIONS

The present application is a continuation of U.S. patent application Ser. No. 16/188,562 filed on Nov. 13, 2018, which is a continuation of U.S. patent application Ser. No. 15/079,360 filed on Mar. 24, 2016, which claims priority to U.S. Patent Application Ser. No. 62/144,629 filed on Apr. 8, 2015.

### BACKGROUND OF THE INVENTION

The present invention is a method and system for wagering on sporting events. Wagering on sporting events continues to be a popular form of gambling. A sportsbook is an entity that functions as a “market maker” for wagering on sporting events. The sportsbook accepts wagers on potential outcomes of a sporting event, paying winning wagers based on established odds for each outcome.

Lottery games are another common and popular form of gambling in which the winners are determined in some random manner. In a lottery game, point-of-purchase terminals for purchasing tickets are commonly found in grocery stores, convenience stores, gas stations, and other retail locations. Each player may purchase a ticket with a player-selected or randomly generated series of numbers. If that series of numbers, or a portion of that series, is selected in a subsequent random drawing or selection of numbers, the player wins a cash amount that may be fixed or may be determined as a percentage of the receipts from tickets for that particular drawing. For another example, instant lottery tickets provide a player the opportunity to win a cash amount (or another prize) without waiting for a subsequent drawing. Specifically, an instant lottery ticket generally includes winning (or losing) numbers or icons that are concealed on the ticket itself. The numbers or icons are typically hidden by a coating. By removing this coating, the player can instantly determine whether or not it is a winning ticket rather than waiting for a subsequent drawing.

It would be desirable to combine a lottery game with wagering on sporting events to achieve a new and appealing game which allows players to place wagers on sporting events by essentially buying lottery-like tickets through the point-of-purchase terminals commonly found in grocery stores, convenience stores, gas stations, and other retail locations.

### SUMMARY OF THE INVENTION

The present invention is a method and system for wagering on sporting events.

In an exemplary implementation of the method and system of the present invention, multiple point-of-purchase terminals are provided at grocery stores, convenience stores, gas stations, and other retail locations. Each such point-of-purchase terminal generally comprises a computer with one or more input means, such as a keyboard, mouse, touch screen, etc. Using such point-of-purchase terminals, a ticket can be purchased in the same manner that current lottery tickets are purchased.

Each ticket includes a series of player-selected numbers (or other alphanumeric characters or symbols) or a series of randomly generated numbers (or other alphanumeric characters or symbols). Each number is assigned to the outcome of a sporting event, including, for example, but not limited to, football games, baseball games, basketball games, hockey games, soccer matches, and horse races. A number could be associated with any potential outcome of a sporting event, including straight-up bets, bets against a point spread, or various proposition (“prop”) bets. For example, with respect to prop bets, for some popular sporting events, it is possible to place wagers on such events as the length of the rendition of the national anthem (over/under), the outcome of the coin toss (heads/tails), the highest scoring quarter or time period (multiple choice), whether a particular back-up or reserve player enter the game (yes/no), or the occurrence of certain unusual plays.

Each of the point-of-purchase terminals is in communication with a first computer server and associated database to record the purchase of each ticket. The first computer server is then in communication with another (or second) computer server and associated database that is hosted by a sportsbook.

When a ticket is purchased, a predetermined portion of the purchase price is treated as a wager and allocated to the sportsbook. Accordingly, the computer server communicates with the computer server hosted by the sportsbook and records the wager.

The remainder of the purchase price is then allocated into other pools, including, in at least some implementations, a secondary payout pool. For example, the secondary payout pool may be used to provide some form of consolation prizes, or it may be used to supplement winning payouts.

At some future date, the outcomes of the sporting events will determine a winning series of numbers. If a player has a matching ticket, i.e., the series of user-selected or randomly generated numbers on the ticket matches the winning series of numbers from the outcomes of the sporting events, the player is a winner and is entitled to a payout. The amount of the payout is then determined by the amount generated by the wager placed with the sportsbook. In this regard, the amount generated by the wager with the sportsbook is calculated by the second computer server hosted by the sportsbook and communicated back to the first computer server.

In those implementations in which the secondary payout pool is accessed to pay consolation prizes, at the time the winner is determined, the first server is also used to make such a determination about consolation prizes.

In those implementations in which the secondary payout pool is used to supplement winning payouts, a determination is made by the first computer server as to whether the payout amount (preliminary amount) exceeds a predetermined minimum amount. If not, the secondary payout pool is accessed to make up the difference, and the predetermined minimum amount is treated as the final payout and awarded to the player.

The method and system of the present invention thus combines a lottery game with wagering on sporting events, allowing players to place wagers on sporting events by essentially buying lottery-like tickets through the point-of-purchase terminals commonly found in grocery stores, convenience stores, gas stations, and other retail locations.

### DESCRIPTION OF THE DRAWINGS

FIG. 1 is a schematic illustration of an exemplary implementation of the method and system of the present invention;

FIG. 2 is a diagram illustrating how the monies associated with the purchase of a ticket are allocated in an exemplary implementation of the method and system of the present invention;

FIG. 3A is a flow chart illustrating a determination of a payout for a ticket in which the monies have been allocated as in FIG. 2; and

FIG. 3B is a flow chart illustrating an alternate determination of a payout for a ticket in which the monies have been allocated as in FIG. 2.

### DETAILED DESCRIPTION OF THE INVENTION

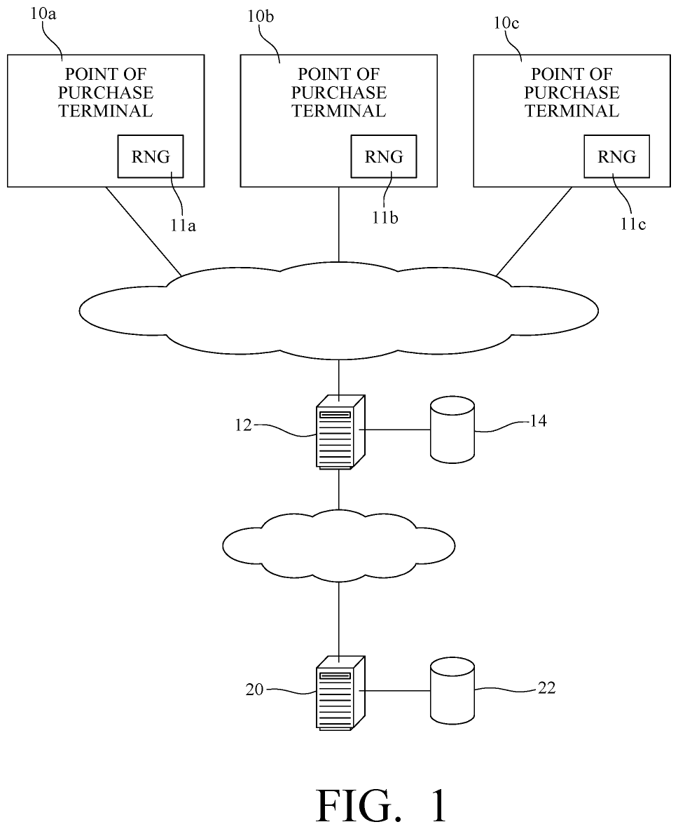

The present invention is a method and system for wagering on sporting events. Referring now to FIG. 1, in an exemplary implementation of the method and system of the present invention, multiple point-of-purchase terminals 10a, 10b, 10c are provided at grocery stores, convenience stores, gas stations, and other retail locations. Such point-of-purchase terminals 10a, 10b, 10c could even be accessible and available via the Internet. Similar to the point-of-purchase terminals that are currently used in lottery operations, each such point-of-purchase terminal 10a, 10b, 10c generally comprises a computer with one or more input means, such as a keyboard, mouse, touch screen, etc. Using such point-of-purchase terminals 10a, 10b, 10c, a ticket can be purchased in the same manner that current lottery tickets are purchased.

In this regard, each ticket includes a series of player-selected numbers or a series of randomly generated numbers. Although numbers may be preferred for simplicity, any alphanumeric characters or other symbols could be used in place of numbers without departing from the spirit and scope of the present invention. With respect to randomly generated numbers, each point-of-purchase terminal 10a, 10b, 10c thus includes a software-implemented random number generator (“RNG”) 11a, 11b, 11c that produces a series of randomly generated numbers for the ticket.

Whether a ticket includes a series of player-selected numbers or a series of randomly generated numbers, Table A is an example of the assignment of certain numbers to the outcomes of multiple sporting events. In short, a number could be associated with any potential outcome of a sporting event, including straight-up bets, bets against a point spread, or various proposition (“prop”) bets.

TABLE A

| | |
|---|---|
| 0 | New York wins over Los Angeles |
| 1 | Los Angeles wins over New York |
| 2 | New York (+2) over Los Angeles |
| 3 | Los Angeles (−2) over New York |
| 4 | Chicago wins over Houston |
| 5 | Houston wins over Chicago |
| 6 | Chicago (+2) over Houston |
| 7 | Houston (−2) over Chicago |
| 8 | Louisville wins over Cincinnati |
| 9 | Cincinnati wins over Louisville |

Again, a purchased ticket could include a series of player-selected numbers or a series of randomly generated numbers. With respect to Table A, the available numbers would be 0-9. For example, a three-number series, whether player-selected or randomly generated, could be 1-6-9 (similar to typical Pick 3 lottery game), but, in this case, would correspond to the outcomes of the three sporting events identified above in Table A. Of course, if random number generation were used to generate the ticket, in certain cases, the random number generator would have to be programmed to eliminate certain combinations. For example, with respect to Table A, a single ticket should not include numbers 0 and 1, as these represent mutually exclusive outcomes (i.e., both New York and Los Angeles could not win the same game.).

For another example, Table B illustrates another possible ticket layout and example of the assignment of certain numbers to the outcomes of multiple sporting events, which is similar to the layout of a common parlay card:

TABLE B

| | | | |
|---|---|---|---|
| 1 | DET | CHI | 2 |
| 3 | LA | NY | 4 |
| 5 | IND | BAL | 6 |
| 7 | JAX | MIA | 8 |
| 9 | CLE | NE | 10 |
| 11 | DEN | SEA | 12 |
| 13 | ARI | CAR | 14 |
| 15 | DAL | GB | 16 |
| 17 | KC | PIT | 18 |
| 19 | PHI | WAS | 20 |

Referring still to FIG. 1, each of the point-of-purchase terminals 10a, 10b, 10c is in communication with a first computer server 12 and associated database to record the purchase of each ticket. Such communications are preferably facilitated through an Internet connection, satellite communications, or similar known means of data transport. The first computer server 12 is then in communication with another (or second) computer server 20 and associated database 22 that is hosted by a sportsbook. As defined above and as used in the present application, a sportsbook is an entity that functions as a “market maker” for wagering on sporting events, i.e., it accepts wagers on sporting events and pays out winnings for successful wagers, whether that entity is associated with a physical location or operates as a virtual entity accessible via the Internet or other computer network. For example, in the context of the present application, a sportsbook could include a state lottery or other non-traditional entity that facilitates wagering on sporting events.

In any event, such communications are again preferably facilitated through an Internet connection, satellite communications, or similar known means of data transport.

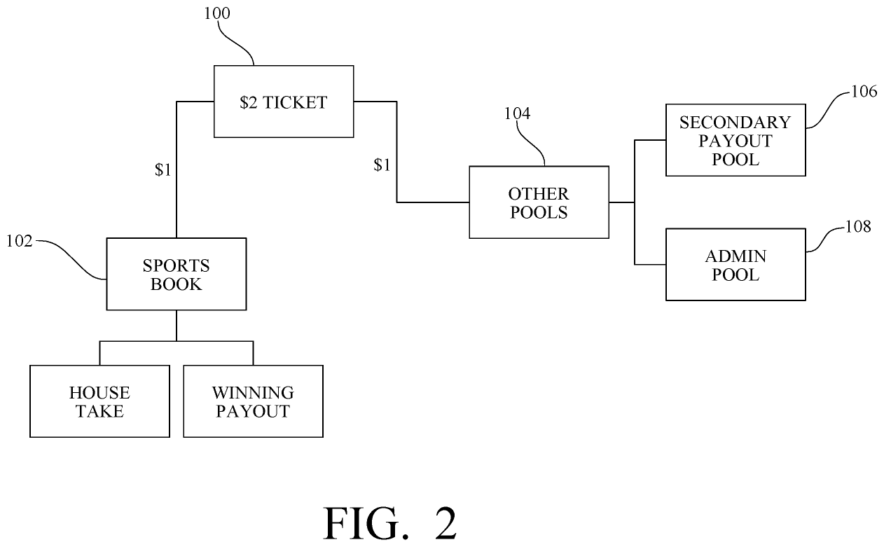

FIG. 2 is a diagram illustrating how the monies associated with the purchase of a ticket are allocated. In FIG. 2, a $2 ticket is purchased, as indicated by block 100. For sake of example, the ticket could be the three-number series 1-6-9, as discussed above. One dollar ($1) of the purchase price is then treated as a wager and allocated to the sportsbook, as indicated by block 102. Accordingly, the first computer server 12 communicates with the second computer server 20 hosted by the sportsbook (as illustrated in FIG. 1) and records the wager, such that a $1 wager is entered for the three outcomes of the sporting events identified in Table A above. This would typically be in the form of a $1 parlay, but could also be in the form of three individual wagers.

The remainder ($1) of the purchase price is then allocated into other pools, as indicated by block 104. In this exemplary implementation, one of the other pools is a secondary payout pool 106 (SECONDARY PAYOUT POOL), which is used to provide some form of consolation prizes, or it may be used to supplement winning payouts, as further described below. Another pool 108 (ADMIN POOL) is then used for administrative expenses and/or other purposes.

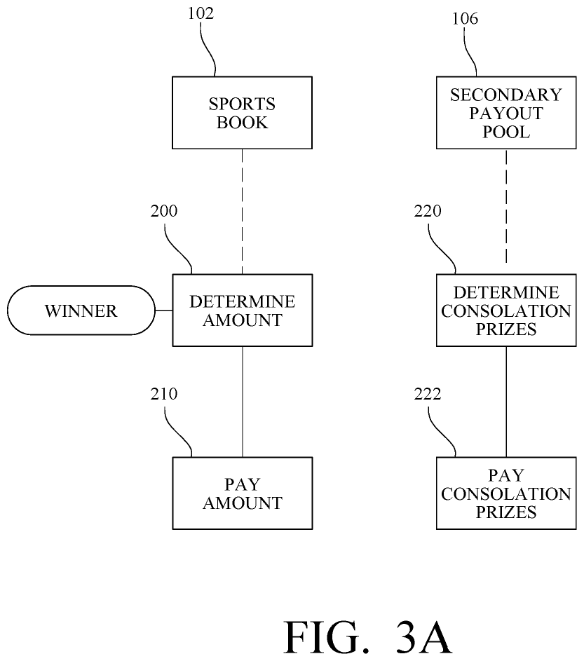

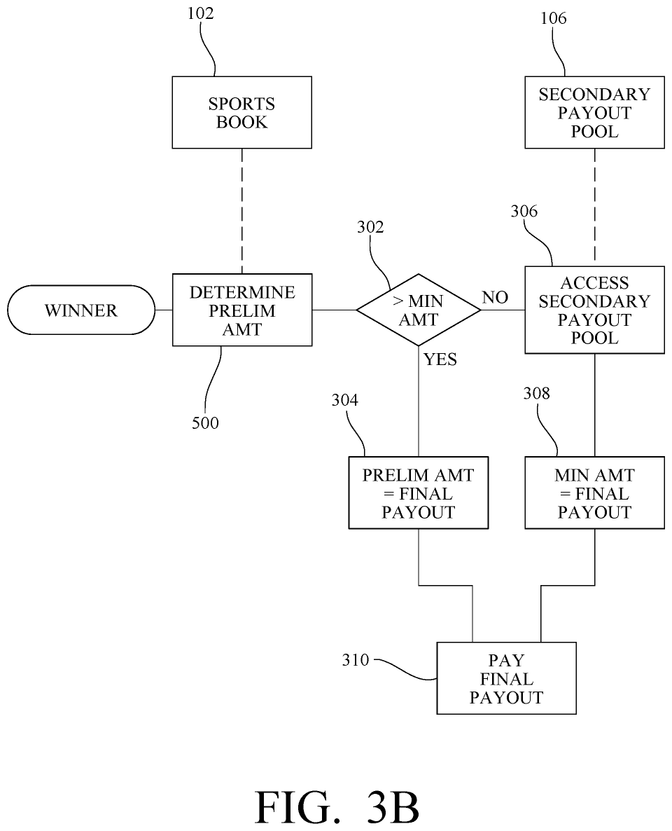

Referring now to FIG. 3A, at some future date, the outcomes of the sporting events will determine a winning series of numbers (or other alphanumeric characters or symbols). If a player has a matching ticket, i.e., the series of user-selected or randomly generated numbers on the ticket matches the winning series of numbers from the outcomes of the sporting events, the player is a winner and is entitled to a payout. In most cases, a player would only have a winning ticket if all numbers on the ticket matched the winning series of numbers.

The amount (AMOUNT) of the payout is then determined by the amount generated by the wager (or wagers) placed with the sportsbook, as indicated by block 200 of FIG. 3A. In this regard, the amount generated by the $1 wager(s) with the sportsbook is calculated by the second computer server 20 hosted by the sportsbook (including any deductions for the house take, etc.) and communicated back to the first computer server 12. In most cases, wagers on sporting events are fixed odds wagers, and the amount generated by the wager would be calculated based on the posted odds at the time of the wager. However, in some cases, the wager may be a pari-mutuel wager. In pari-mutuel wagering, all wagers are collected in a pool, and the payoff odds are then calculated by sharing the pool (minus any house take, etc.) among all winning wagers. In any event, the amount calculated by the second computer server 20 hosted by the sportsbook is then paid to a playing holding the winning ticket or set aside until the player presents the winning ticket, as indicated by block 210.

As also shown in FIG. 3A, in some implementations, at the time the winner is determined, the secondary payout pool 106 may be accessed to determine consolation prizes, as indicated by block 220. Such determination is made by the first computer server 12. The consolation prizes are then paid to players holding qualifying tickets or set aside until players present those tickets, as indicated by block 222.

With respect to accessing the secondary payout pool 106 and awarding consolation prizes, in some cases, consolation prizes would be awarded to “partial” winners based on the matching of some, but not all, numbers. For example, referring back to Table B, a consolation prize might be awarded to a player who had eight or nine games correct, but not all ten.

Referring now to FIG. 3B, in an alternate implementation, at some future date, the outcomes of the sporting events will determine a winning series of numbers (or other alphanumeric characters or symbols). If a player has a matching ticket, i.e., the series of user-selected or randomly generated numbers on the ticket matches the winning series of numbers from the outcomes of the sporting events, the player is a winner and is entitled to a payout. As stated above, in most cases, a player would only have a winning ticket if all numbers on the ticket matched the winning series of numbers.

The preliminary amount (PRELIM AMT) of the payout is then determined by the amount generated by the wager (or wagers) placed with the sportsbook, as indicated by block 300 of FIG. 3B. In this regard, the amount generated by the $1 wager(s) with the sportsbook is calculated by the second computer server 20 hosted by the sportsbook (including any deductions for the house take, etc.) and communicated back to the first computer server 12. Then, a determination is made by the first computer server 12 at decision 302 as to whether this preliminary amount (PRELIM AMT) exceeds a predetermined minimum amount (MIN AMT). If so, that preliminary amount (PRELIM AMT) is treated as the final payout (FINAL PAYOUT), as indicated by block 308. If not, the secondary payout pool 106 is accessed to make up the difference, as indicated by block 306, and the predetermined minimum amount (MIN AMT) is treated as the final payout, as indicated by block 308. In either case, the final payout is then paid to a player holding the winning ticket or set aside until the player presents the winning ticket, as indicated by block 310.

The method and system of the present invention, as described above with reference to FIGS. 1-2, 3A, and 3B, thus combines a lottery game with wagering on sporting events, allowing players to place wagers on sporting events by essentially buying lottery-like tickets through the point-of-purchase terminals commonly found in grocery stores, convenience stores, gas stations, and other retail locations.

In certain jurisdictions, it may be necessary or desirable to allow only for the purchase of tickets with a series of randomly generated numbers (or other alphanumeric characters or symbols), similar to a “quick pick” or similar automated number selection in lottery games. In that case, the game would be more akin to a lottery, in which chance plays the predominant role in determining the outcome.

One of ordinary skill in the art will recognize that additional implementations and/or embodiments are also possible without departing from the teachings of the present invention. This detailed description, and particularly the specific details of the exemplary implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A system for wagering on one or more sporting events, comprising:
multiple point-of-purchase terminals at multiple retail locations, each such point-of-purchase terminal for generating tickets, each ticket including a series of randomly generated symbols, each symbol corresponding to a selected outcome associated with the one or more sporting events, wherein each ticket is acquired for a purchase price;
a first computer server managed by a first entity and in communication with the multiple point-of-purchase terminals for recording the generation of each ticket, the first computer server allocating a first portion of the purchase price of each ticket to one or more wagers on the selected outcomes, and the first computer server allocating a second portion of the purchase price of each ticket to a secondary payout pool; and
a second computer server administered by a sportsbook for managing the one or more wagers, the second computer server in communication with the first computer server, and the second computer server receiving and recording the one or more wagers;
wherein, after occurrence of the one or more sporting events results in a series of winning outcomes, the first computer server (i) determines whether the series of randomly generated symbols on each ticket matches the series of winning outcomes, and if so, determines an amount of a payout from the one or more wagers via communication with the second computer server that manages the one or more wagers.

2. The system as recited in claim 1, wherein, after occurrence of the one or more sporting events results in the series of winning outcomes, the first computer server also (ii) determines whether any consolation prizes are to be awarded, and if so, accesses the secondary payout pool to pay such consolation prizes.

3. The system as recited in claim 1, wherein, after occurrence of the one or more sporting events results in the series of winning outcomes, the first computer server also (ii) determines whether the amount of the payout from the one or more wagers exceeds a predetermined minimum amount, and if not, uses the secondary payout pool to supplement the payout from the one or more wagers, resulting in a final payout.

4. The system as recited in claim 1, wherein the symbols are alphanumeric characters.

5. The system as recited in claim 1, wherein the first entity is an administrator of a lottery, and the multiple point-of-purchase terminals are also configured to generate lottery tickets.

6. A system for wagering on one or more sporting events, comprising:
multiple point-of-purchase terminals at multiple retail locations, each such point-of-purchase terminal for generating tickets, each ticket including a series of player-selected symbols, each symbol corresponding to a selected outcome associated with the one or more sporting events, wherein each ticket is acquired for a purchase price;
a first computer server managed by a first entity and in communication with the multiple point-of-purchase terminals for recording the generation of each ticket, the first computer server allocating a first portion of the purchase price of each ticket to one or more wagers on the selected outcomes, and the first computer server allocating a second portion of the purchase price of each ticket to a secondary payout pool; and
a second computer server administered by a sportsbook for managing the one or more wagers, the second computer server in communication with the first computer server, and the second computer server receiving and recording the one or more wagers;
wherein, after occurrence of the one or more sporting events results in a series of winning outcomes, the first computer server (i) determines whether the series of player-selected symbols on each ticket matches the series of winning outcomes, and if so, determines an amount of a payout from the one or more wagers via communication with the second computer server that manages the one or more wagers.

7. The system as recited in claim 6, wherein, after occurrence of the one or more sporting events results in the series of winning outcomes, the first computer server also (ii) determines whether any consolation prizes are to be awarded, and if so, accesses the secondary payout pool to pay such consolation prizes.

8. The system as recited in claim 6, wherein, after occurrence of the one or more sporting events results in the series of winning outcomes, the first computer server also (ii) determines whether the amount of the payout from the one or more wagers exceeds a predetermined minimum amount, and if not, uses the secondary payout pool to supplement the payout from the one or more wagers, resulting in a final payout.

9. The system as recited in claim 6, wherein the symbols are alphanumeric characters.

10. The system as recited in claim 6, wherein the first entity is an administrator of a lottery, and the multiple point-of-purchase terminals are also configured to generate lottery tickets.

11. A method for wagering on one or more sporting events, comprising the steps of:
establishing a network of multiple point-of-purchase terminals at multiple retail locations, with each of the multiple point-of-purchase terminals in a communication with a first computer server managed by a first entity;
generating a ticket at one of the multiple point-of-purchase terminals that includes a series of player-selected symbols or a series of randomly generated symbols, each symbol corresponding to a selected outcome associated with each of the one or more sporting events, wherein the ticket is acquired for a purchase price;
recording the generation of the ticket at the first computer server;
allocating a predetermined portion of the purchase price to a wager on the selected outcomes and placing the wager in the amount of the predetermined portion of the purchase price with a sportsbook via communication between the first computer server and a second computer server hosted by the sportsbook;
allocating another portion of the purchase price to a secondary payout pool which is managed by the first entity; and
determining, after occurrence of the one or more sporting events results in a series of winning outcomes, and using the first computer server, whether the series of player-selected symbols or the series of randomly generated symbols on the ticket matches the series of winning outcomes, and if so, determining, using the first computer server, an amount of a payout from the wager via communication with the second computer server hosted by the sportsbook.

12. The method as recited in claim 11, and further comprising the step of:
determining, after occurrence of the one or more sporting events results in the series of winning outcomes, and using the first computer server, whether any consolation prizes are to be awarded, and if so, accessing the secondary payout pool to pay such consolation prizes.

13. The method as recited in claim 11, and further comprising the step of:
determining, using the first computer server, whether the amount of the payout from the wager exceeds a predetermined minimum amount, and if not, using the secondary payout pool to supplement the payout from the wager, resulting in a final payout.

14. The method as recited in claim 11, wherein the wager comprises a series of individual wagers, one associated with each symbol included on the ticket.

15. The method as recited in claim 11, wherein the symbols are alphanumeric characters.
